(19) United States
(12) Patent Application Publication
(10) Pub. No.: US 2018/0300739 A1
(43) Pub. Date: Oct. 18, 2018

(54) METHODS AND SYSTEMS FOR MULTI-SOURCED REPORTING OF CROWD INFORMATION

(71) Applicant: Sunil S. INGLE, Sunnyvale, CA (US)

(72) Inventor: Sunil S. INGLE, Sunnyvale, CA (US)

(21) Appl. No.: 15/953,410

(22) Filed: Apr. 14, 2018

Related U.S. Application Data
(60) Provisional application No. 62/485,824, filed on Apr. 14, 2017.

(51) Int. Cl. G06Q 30/02

(52) U.S. Cl. CPC G06Q 30/0202

(57) ABSTRACT

A method and a system for multi-sourced reporting of crowd information is provided. The method comprises receiving a plurality of sales reports from a plurality of merchant terminals. Each merchant terminal is associated with a business service among a plurality of business services and each sales report comprises an order information. The method also includes determining one of a wait time and a rush status for each of the business service by computing one or more metrics. The method further includes predicting rush trends at each of the business service by determining a weather factor at each of the business service based on a weather information. Furthermore, the method includes facilitating display of at least one of the wait time, the rush status and the rush trends at a selected business service on a crowd reporting interface in response to a user request received from a user.

### TECHNICAL FIELD

The present disclosure generally relates to crowd reporting and, more particularly, to methods and systems for multi-sourced reporting of crowd information at a business service or a location.

### BACKGROUND

With the increased use of portable mobile devices, such as mobile phones, users have access to an assortment of applications to obtain a variety of useful real-time information including crowd information about a place of interest such as airport, bus station, convention center, shopping area, restaurant, theme park, etc. The real-time information on crowd reduces anxiety levels of a traveller. Current crowd reporting applications rely entirely on traditional crowd reporting sources such as, public entity and private entity sources. However, such applications typically do not consider crowd sourced data that can provide updated or real-time crowd data that may not otherwise be available from traditional sources. Additionally, such applications provide inadequate crowd data in terms of rush status, trends, waiting time and do not provide projections based on weather and in some cases do not provide projections at all. Further, most applications rely on Global Positioning System (GPS) tracking and check-in feature of social platforms to determine crowd data in a location. However, such applications fail to verify proximity of users reporting about a location in an offline mode when the users disable location services, thereby resulting in errors in the crowd data.

In view of the above, there is a need for methods and systems for multi-sourced crowd reporting of crowd data at a place to generate more accurate and reliable crowd reports, heat maps or density maps, and forecasts.

### SUMMARY

Various embodiments of the present disclosure provide methods and systems for multi-sourced reporting of crowd information.

In an embodiment, a method for multi-sourced reporting of crowd information is disclosed. The method comprises receiving a plurality of sales reports from a plurality of merchant terminals. Each merchant terminal is associated with a business service among a plurality of business services and each sales report comprises an order information. The method also includes determining one of a wait time and a rush status for each of the business service by computing one or more metrics based on the sales report of the business service. The method further includes predicting rush trends at each of the business service by determining at least a weather factor at each of the business service based on a weather information and a historical data associated with each of the business service. The weather information affecting the rush trends at each of the business service are received from an external system. The historical data comprises an aggregation of at least one of the rush status or the wait time at each of the business service over a time period. Furthermore, the method includes facilitating display of at least one of the wait time, the rush status and the rush trends at a selected business service on a crowd reporting interface in response to a user request received from a user. The user request comprises the selected business service among the plurality of business services.

In another embodiment, a system for multi-sourced reporting of crowd information is disclosed. The system comprises a memory and at least one processor. The system comprises stored instructions and the at least one processor is configured to execute the stored instructions. The system is configured to receive a plurality of sales reports from a plurality of merchant terminals. Each merchant terminal is associated with a business service among a plurality of business services and each sales report comprises an order information. The system is also configured to determine one of a wait time and a rush status for each of the business service by computing one or more metrics based on the sales report of the business service. The system is further configured to predict rush trends at each of the business service by determining a weather factor at each of the business service based on a weather information. The weather information affecting the rush trends at each of the business service received from an external system and a historical data is associated with each of the business service. The historical data comprises an aggregation of one of the rush status or the wait time at each of the business service over a time period. Furthermore, the system is configured to facilitate display of one of the wait time, the rush status and the rush trends at a selected business service on a crowd reporting interface in response to a user request received from a user. The user request comprises the selected business service among the plurality of business services.

In an embodiment, a method for multi-sourced reporting of crowd information is disclosed. The method comprises facilitating receipt of a user request on a crowd reporting interface. The user request comprises a location. The method also includes determining a wait time and a rush status at the location based on a user report, a sales report and a crowd report. The user report is provided by a user on the crowd reporting interface. The user report is provided by the user in proximity with the location. The sales report comprises an order information from a merchant terminal associated with the location. The crowd report of the location is received from an external system. The method further includes predicting rush trends at the location by determining a weather factor at the location based on a weather information and a historical data associated with the location. The weather information affecting the rush trends at the location are received from the external system. The historical data comprises an aggregation of one of the rush status or the wait time at the location over a time period. Furthermore, the method comprises facilitating display of at least one of the wait time, the rush status and the rush trends at the location on the crowd reporting interface in response to the user request.

### BRIEF DESCRIPTION OF THE FIGURES

For a more complete understanding of example embodiments of the present technology, reference is now made to the following descriptions taken in connection with the accompanying drawings in which:

FIG. 1 illustrates an environment, where at least some example embodiments can be practiced;

FIG. 2 is an example illustration of a multi-sourced crowd reporting system, in accordance with an example embodiment;

FIG. 3 is a schematic illustration depicting effects of weather factor in crowd projections, in accordance with an example embodiment;

FIG. 4 illustrates a flow diagram of an example method for determining rush rating and wait time at a business service, in accordance with an example embodiment;

FIG. 5A illustrates a flow diagram of an example method for receiving crowd information at a location or business service on a user device, in accordance with an example embodiment;

FIG. 5B illustrates a flow diagram of an example method of a user reporting crowd information at a location or a business service via a user device, in accordance with an example embodiment;

FIG. 6 illustrates a flow diagram of an example method of a business service providing a plurality of sales report for determining crowd information at a business service, in accordance with an example embodiment;

FIG. 7A illustrates a flow diagram of an example method for sending a notification from a merchant terminal to one or more users, in accordance with an example embodiment;

FIG. 7B illustrates a flow diagram of an example method for sending a notification to a third party reporting service, in accordance with an example embodiment;

FIG. 7C illustrates a schematic representation of a crowd reporting interface displaying notifications, in accordance with an example embodiment;

FIG. 7D illustrates a service provider interface displaying a UI of the crowd reporting interface, in accordance with an example embodiment;

FIG. 8 illustrates a schematic representation of a crowd reporting interface, in accordance with an example embodiment;

FIG. 9 illustrates a schematic representation of a user reporting crowd information on a crowd reporting interface, in accordance with an example embodiment;

FIG. 10 illustrates a schematic block diagram of a mobile device, in accordance with an example embodiment; and

FIG. 11 illustrates a schematic block diagram of a server, in accordance with an example embodiment.

The drawings referred to in this description are not to be understood as being drawn to scale except if specifically noted, and such drawings are only exemplary in nature.

### DETAILED DESCRIPTION

Various methods, systems and computer readable mediums for multi-sourced reporting of crowd information are disclosed.

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Various example embodiments of the present disclosure provide methods, systems, user devices and computer program products for multi-sourced reporting of crowd information at business services or a location. In an embodiment, a crowd reporting interface can be accessed by a user on a user device to acquire crowd information at a business service or a location. The user can place a user request to a server for retrieving crowd information at a particular location or business service. The crowd information is displayed to the user in terms of wait time, rush status and rush trends on the crowd reporting interface.

In an embodiment, the business services are equipped with merchant terminals that are configured to share order data of the business service with the server. The order data can be used to determine operational efficiency or sales based efficiency of the business service in terms of crowd information such as, rush status and wait time. Additionally or optionally, users can report the rush status and the wait time at business services or locations when they are in the vicinity of the business service or the location using the crowd reporting interface. The user searches for the business service/location in the vicinity he/she chooses to report and provides a rush status and/or wait time to avail service at the business service. The server checks user reports provided by the user for a proximity factor and reporting frequency. The proximity factor is determined as a distance measure between the business service/location and the user providing the user report. The reporting frequency corresponds to number of times the user reports about the location/business service or user reports for different business services/location in a day. The user reports are discarded by the server when the proximity factor is greater than a proximity threshold indicating that the user is not within a close proximity of the business service/location he/she is reporting about. Similarly, the user reports are discarded when the user reports exceed a reporting frequency threshold.

In another embodiment, external systems can be accessed by the server such as to retrieve crowd information that is used to determine rush status, wait time and rush trends at the business service or the location. The server determines rush status and wait time at the business service by aggregating rush status and wait time received from users in the vicinity, order data from the merchant terminals and the external system. Alternatively, rush status and wait time at a location may be determined based on rush status and wait time received from users in the vicinity and the crowd information received from the external system.

In an embodiment, rush trends at a business service/location are predicted based on historical data. Additionally, weather factor is incorporated into the historical data such as to predict the rush trend at the business service/location. The weather factor determined based on weather information affects crowd information. For example, in spite of the historical data suggesting a huge crowd at a business service for a particular time of day, extreme temperatures, say, heavy rain may affect the prediction of the rush trends at the business service and indicate a lesser crowd.

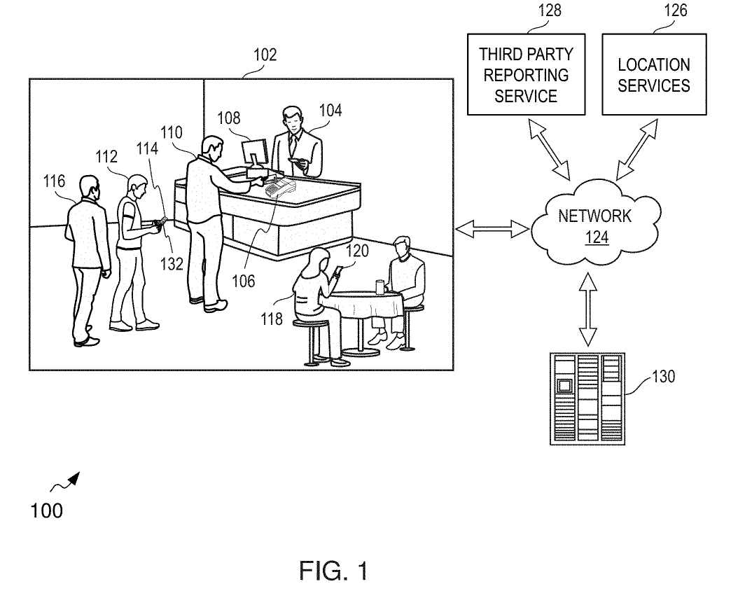

FIG. 1 shows an example representation of an environment 100, where at least some embodiments of the present disclosure can be implemented.

An example representation of the environment 100 is shown depicting a communication network (e.g., a network 124) that connects entities such as, a merchant facility 102, a server 130, a location service 126 and a third party reporting service 128. The network 124 may be a centralized network or may comprise a plurality of sub-networks that may offer a direct communication between the entities or may offer indirect communication between the entities. Examples of the network 124 include stand alone or a combination of a local area network (LAN), a wide area network (WAN), wireless, wired, any currently existing or to be developed network that can be used for communication. More specifically, an example of the network 124 can be the Internet which may be a combination of a plurality of networks.

In the illustrated embodiment, the merchant facility 102, an eatery, catering to food services of customers is shown. The merchant facility 102 may be managed by a merchant such as a merchant 104, a group of merchants or an agent. Examples of the merchant facility 102 may include any retail shop, supermarket, business establishment, fuel stations, private agencies, ticket counters, or any such place or establishment where customers visit for buying any goods and/or services. The merchant facility 102 is shown as equipped with a merchant terminal/POS terminal 106 and a merchant interface device 108. The merchant interface device 108 can be a telephone or a computer system operated by the agent 104 for performing payment transactions on behalf of a customer 110. As seen in FIG. 1, the merchant interface device 108 is a computer system operated by the agent 104.

As can be seen from the environment 100, customers 110, 112, 116 wait in a queue to perform a financial transaction at the POS terminal 106 of the merchant facility 102 for availing food service at the merchant facility 102. It shall be noted that more than one such POS terminals can be present in the merchant facility 102. Moreover, the customers 118, 112 who completed financial transaction in exchange for food services at the POS terminal 106 are seen dining at a table. The customers 110, 112, 116, 118, 122 may have one or more mobile devices for example, the user 112 has a device 114 and the user 118 has a device 120. Examples of the devices 114 and 120 are not limited to mobile phones only, and the devices 114 and 120 may take examples of any portable electronic device (e.g., laptops, smartphones and tablets) having cellular communication capabilities. For instance, the devices 114 and 120 may be equipped with subscriber identity module (SIM) or Removable User Identity Module (R-UIM) to enable cellular communication.

In an embodiment the customers 112, 118 equipped with the user devices 114, 120 can access the server 130 to download a crowd reporting interface 132 (i.e. a crowd reporting application) for providing user reports comprising crowd information, such as, wait time, rush status at a location or business service (e.g., the merchant facility 102) via the devices 114, 120. It shall be noted that business service refers to establishments offering products/services in return for payments and locations refer to places such as, playground, bus terminals, and parks providing facilities without payments. Additionally, the customers 112, 118 can access the interface 132 for viewing crowd information at a location/business service. The customers 112, 118 can access the interface 132 by signing up (e.g., by making a profile) for the interface 132 or in a guest mode.

In conventional scenarios, the customers 110, 112, 116, 118, 122 would reach the POS terminal 106 upon his/her turn and place an order for food of choice and the agent 104 uses the merchant terminal 106 to acquire order information associated with each of the customers 110, 112, 116, 118, 122. The customers 110, 112, 116, 118, 122 perform payment transaction corresponding to the order information at the POS terminal 106. As can be seen from the environment 100, the customer 110 is making the financial transaction at the POS terminal 106. It shall be noted that more than one such POS terminals can be present in the merchant facility 102.

The crowd information collected from business services (e.g., the merchant facility 102), the third party reporting service 128 and the plurality of users (the customers 112, 118) is processed by the server 130 to display wait time and rush status for a location/business service by computing one or more metrics such as, throughput, total wait time. Business services, such as, the merchant facility 102 register with the interface 132 for providing data related to crowd information directly to the server 130. For instance, order data obtained directly from the POS terminal 106 are provided to the server 130. The third party reporting service 128 includes crowd data obtained from external systems such as, government databases and other external services accessible by the server 130. The server 130 is configured to aggregate crowd information from multiple sources (e.g., the customers 112, 118, the third party reporting service 128, the merchant facility 102) and compute metrics related to crowd information in a location/business service. The metrics are used by the server 130 to determine rush status and wait time at the location/business service.

In an embodiment, the server 130 predicts rush trends at the merchant facility 102. The rush trends at the merchant facility 102 are displayed on the crowd reporting interface 132 accessible by the customers 112, 118. The server 130 uses historical data associated with the merchant facility 102 to predict rush trends at the merchant facility 102. Additionally, the server 130 determines a weather factor that influences the rush trends at the merchant facility 102. The server 130 computes the weather factor based on weather information at location of the merchant facility 102 received from a service provider, such as, the third party reporting service 128. In a non-limiting example, the server 130 uses Hooke's Law to predict rush trends based on the weather factor at business services or locations (e.g., the merchant facility 102).

In an embodiment, the merchant facility 102 can send notifications to users via the crowd reporting interface 132 on associated user devices. The notification can be generated by the merchant interface device 108 and/or merchant terminal 106 and relied to the user, for example the user 112 via the user device 114. It shall be noted that the notification may be in any format such as, text, image, video, audio, link or any combination of the above formats. The notification may be automatically generated by the merchant interface device 108 and/or merchant terminal 106 upon detecting a large deviation from the rush trend predicted at the merchant facility 102. It shall be noted that the crowd reporting interface 132 sets an upper bound on number of notifications and time interval between sending subsequent notifications from the merchant facility 102 by the merchant interface device 108 and/or merchant terminal 106. Alternatively, the merchant 104 may customize the notification and send the notifications to the users. In an embodiment, the notifications generated by the merchant facility 102 are relied only to those users who have added a favorite flag to the merchant facility 102 in the crowd reporting interface 132.

The server 130 is configured to host and manage the interface 132 and communicates with user devices, such as the devices 114 and 120, for downloading the interface 132. The interface 132 may be installed on the devices 114, 120 using application stores associated with Apple iOS™, Android™ OS, Google Chrome OS, Symbian OS®, Windows Mobile® OS, Windows Phone, BlackBerry OS, Embedded Linux, webOS, Palm OS® or Palm Web OS™, and the like.

The user 118 at the merchant facility 102 accesses the interface 132 to report the crowd information at the merchant facility 102. The user 118 can search for the merchant facility 102 by providing a search term corresponding to the merchant facility 102. The user 118 provides crowd information, such as, wait time to avail food service at the merchant facility 102 and a rush rating at the merchant facility 102. The user 118 provides the rush rating at the merchant facility 102 on a scale of 5. The user 118 submits his/her user report comprising the crowd information on the interface 132. It shall be noted that for the user 112 to provide user report about the merchant facility 102 may require the user to turn on location tracking (e.g., GPS) on the device 114. In an embodiment, the user 112 can access the interface 132 via the device 114 to view the crowd information at the merchant facility 102. The user 112 searches for the desired location (e.g., the merchant facility 102).

The environment 100 also includes the location services 126. The devices 114 and 120 use the location services 126, such as, GPS for providing location information to the server 130. The location information of the device 114, 120 are determined from GPS co-ordinates obtained from the location services 126. For instance, the user 112 can permit the crowd reporting interface 132 to track location of the user 112 via the device 114 accessing the location service 126. However, location tracking of the user 112 is not mandatory if the user 112 is browsing places and the user can choose to switch OFF location tracking provided by the location services 126. The crowd reporting interface 132 provides a notification to the user 112 on the user device 114 for enabling the location services 126 when location tracking is needed for providing crowd information to the user 112.

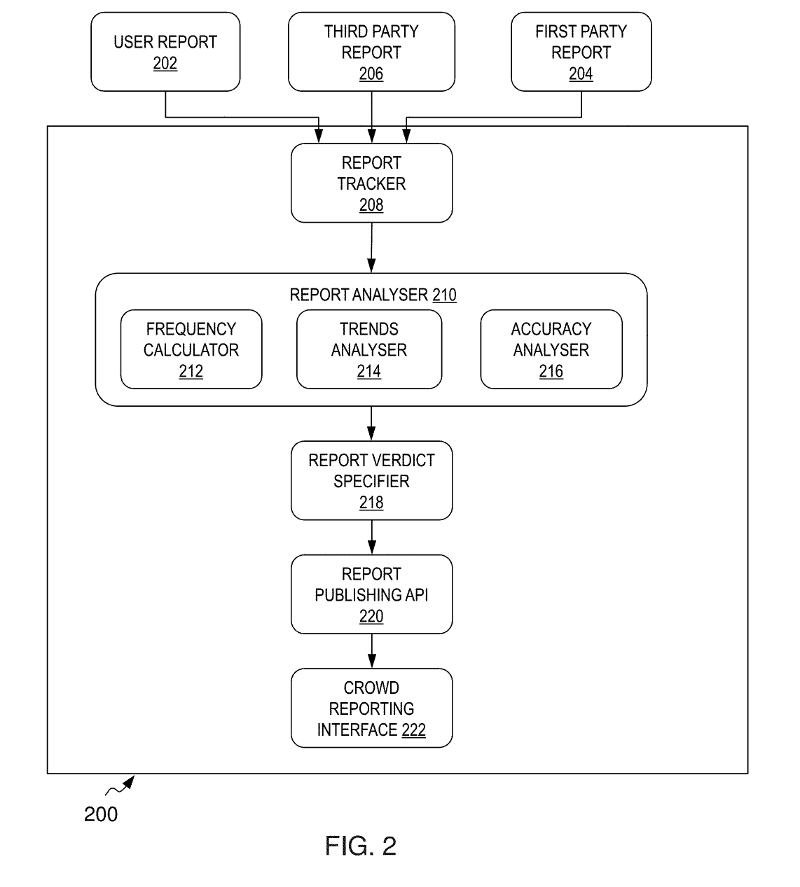

Referring now to FIG. 2, an example illustration of a multi-sourced crowd reporting system 200 is illustrated in accordance with an example embodiment. The system 200 can be implemented in the server 130, or can be implemented in form of one or more distributed elements accessible to the server 130.

The system 200 includes a report tracker 208, a report analyser 210, a report verdict specifier 218, a report publishing API 220 and a crowd reporting interface 222. The system 200 is configured to receive reports from various sources such as a plurality of users (e.g., the consumers 112, 118), a first party service (e.g., business services) and a third party service. For instance, the report tracker 208 consumes crowd information from multiple sources such as a user report 202, a first party report 204 and a third party report 206. The user report 202 provided by a user comprises crowd information in terms of rush rating and wait time at the business service/location that is being reported by the user. For example, the user report 202 provided by the user 118 reporting crowd information at the merchant facility 102 comprises a rush rating of 4 indicating huge crowd and a wait time of 20 minutes for availing a food service at the merchant facility 102.

In an embodiment, a user (e.g., the user 112) may access an interface, such as the crowd reporting interface 132 on the user device 114 for reporting the crowd information corresponding to a location/business service. The user can sign up for the interface 132 and access the interface 132 for providing the user report 202. Alternatively, the user can provide the user report 202 via the interface 132 in a guest mode. The user associated with a user device can only report ‘X’ amount of places per day, where ‘X’ is determined by the history of accuracy of the user report 202. It must be noted that the user can only report crowd information associated with a location if the user is physically present at the location or in proximity of the location, determined by a proximity factor. The proximity factor is a distance measure between current location of the user and the location/business service reported by the user. The user's current location can be determined from latitude and longitude data obtained from location services, such as, the location service 126. Alternatively, if the crowd information provided by the user does not include location information (corresponding to location/business service), then the user report 202 provided by the user corresponding to crowd information of the location/business service is discarded by the system 200.

The first party report 204 is provided by business services (e.g., the merchant facility 102) that have registered with the crowd reporting interface (e.g., the interface 132) for providing order data directly from POS machine, such as, the merchant terminal 106 to the report tracker 208. The first party report 204 provided by the merchant terminals of the business services are used to compute one or more metrics, such as, operational efficiency, sales based efficiency, that are used to determine at least a wait time and a rush status at the business services.

Operational efficiency is determined for business services that process orders in timely basis such as, restaurants. The first party report 204 (also referred to as ‘order data’) acquired from the merchant terminal can be used to determine operational efficiency of the business service. For instance, the operational efficiency can be computed based on throughput of the POS system (e.g., the merchant terminal 106). The operational efficiency is determined form the first party report 204 based on speed and response time of the merchant terminal of the business service. Speed of the merchant terminal associated with the business service indicates speed with which specific workload is completed, and response time indicates amount of time lapsed between a user requesting a service and receipt of the service. The rush status and wait time are determined based on operation efficiency using the following equations:

$$\begin{matrix} neta = \frac{orders closed}{orders received} * 100 & ( 1 ) \\ Total wait time = sum ( time order ( s ) closed - time order ( s ) received ) & ( 2 ) \\ Average wait time = \frac{total wait time}{number of orders closed} & ( 3 )\end{matrix}$$

### Where

neta is efficiency of a business service and provides throughput of the business service (range 0-100%)
eta is normalized efficiency of the business service (range 0-5)
It shall be noted that the throughput (eta) of the business service provides rush status at the business service. The rush status at the business service is provided on a normalized scale of range (0-5).

Sales efficiency is determined for business services, such as, broadway, movie theatres, theme park, sports area, music concert, cinema halls, convention centers or stadiums that open ticket sale pre-event based on the first party report 204 provided by the business service. Sales efficiency is determined as throughput and normalized on a scale of 0-5 to provide normalized efficiency of the business service. The normalized efficiency is indicative of the rush status at the business service. For instance, the first party report 204 comprises sales report that indicates number of orders completed on a specific day or time for a specific service. The throughput for such business services is computed using equation (4) and wait time using equation (5).

$$\begin{matrix} t = \frac{tickets sold}{total capacity} * 100 & ( 4 ) \\ Average wait time = rate at which person is served * {n}^{th} business hour * total sales & ( 5 )\end{matrix}$$

### Where,

‘t’ is throughput and it ranges between 0-100%
eta is normalized efficiency of the business service (range 0-5)
It shall be noted that the ‘eta’ (normalized efficiency of the business service) provides rush status at the business service. The rush status at the business service is provided on a normalized scale of range (0-5).

The third party report 206 are provided by a third party reporting service (e.g., the third party reporting service 128) that provides crowd data obtained from external systems such as, government databases and other external services. The third party service can compute crowd information such as “Busy” or “Delay”. The third party reporting service provides the third party report 206 accessed from a data source (e.g., external system) with consent from the data source to display their name in the third party report 206. For example, airline services or other services like food delivery services just provided rush status update based on the crowd information as the third party report. In another embodiment, the third party services can provide their raw data to the report tracker 208 in order to determine crowd information, such as, rush status and wait time. In an embodiment, the third party reporting service computes rush status and wait time for the business services/locations for which they are generating the third party report 206. In case it's not possible to generate rush status, rush ratings and wait time like stats, the system will name reporting by the data source with consent from data source to display their name.

The report analyzer 210 is configured to receive and analyze the reports 202, 204 and 206 from all sources (plurality of users, business services and the third party reporting service). The report analyzer 210 is configured to perform operations on crowd information data to generate publishable reports. For instance, the report analyser 210 aggregates the wait time and the rush rating for the business service based at least on the user report 202, the first party report 204 of the business service and the third party report 206 (crowd report) from the third party reporting service.

The report analyzer 210 includes a frequency calculator 212, a trend analyzer 214 and an accuracy analyzer 216. The frequency calculator 212 is configured to determine reporting frequency of a user, for example, the user 112 reporting crowd information of a business service on the interface 222. The frequency calculator 212 discards the user report 202 of the user when the reporting frequency exceeds a pre-defined reporting threshold. The trend analyzer 214 aggregates the reports 202, 204 and 206 over time (historical data) for determining rush trends (crowd trends) at a location/business service. For instance, the trend analyzer 214 analyses historical data corresponding to the reports 202, 204 and 206 for a merchant facility (e.g., the merchant facility 102) to determine rush trend based on at least one of a time, a day, a week or a month. In an embodiment, a weather factor affects rush trends at a location/business service. The weather factor is determined from weather information associated with the business service/location. For example, the trend analyzer 214 analyses trends of a park based on historical data corresponding to the reports 202, 204, 206 and weather information to generate visual statistics such as graphs depicting rush trends at the park. The visual statistics depict rush trends of the park on a given day where rush trend peaks in evening during summer season.

The accuracy analyzer 216 analyses accuracy of the user reports 202 provided by the user. The accuracy analyzer 216 compares user reports with the third party reports 206 and/or the first party reports 204 corresponding to the location/business service to determine the accuracy of the user report 202. It must be noted that the report analyzer 210 sets limits on number of the user reports 202 that can be provided by the user based on the accuracy of previous reports as determined by the accuracy analyzer 216.

The report verdict specifier 218 is configured to specify a verdict based on the reports 202, 204 and 206 that were analysed by the report analyser 210. The report verdict specifier 218 is also configured to send the verdict based on the reports 202, 204 and 206 for publishing.

As shown below in Table. 1, the reports 202, 204 and 206 are analysed by the report analyzer 210, and based on the crowd ratings recommended by the report analyzer 210, the report verdict specifier 218 provides crowd information at a location/business service in terms of rush statuses to the user.

TABLE 1

| Status | Rush Rating |
|---|---|
| No Reports | 0 |
| Less Crowded | 1-3 |
| Moderately Crowded | 3-4 |
| Very Crowded | >4 |

The report publishing Application Programming Interface (API) 220 is configured to notify the rush status and the wait time on the crowd reporting interface 222 operable on platforms, such as, iOS and Android about the verdict of the reports 202, 204 and 206 provided by the report verdict specifier 218. The crowd reporting interface 222 allows users to view and report crowd information in terms of rush status and wait time for a business service/location of specific interest.

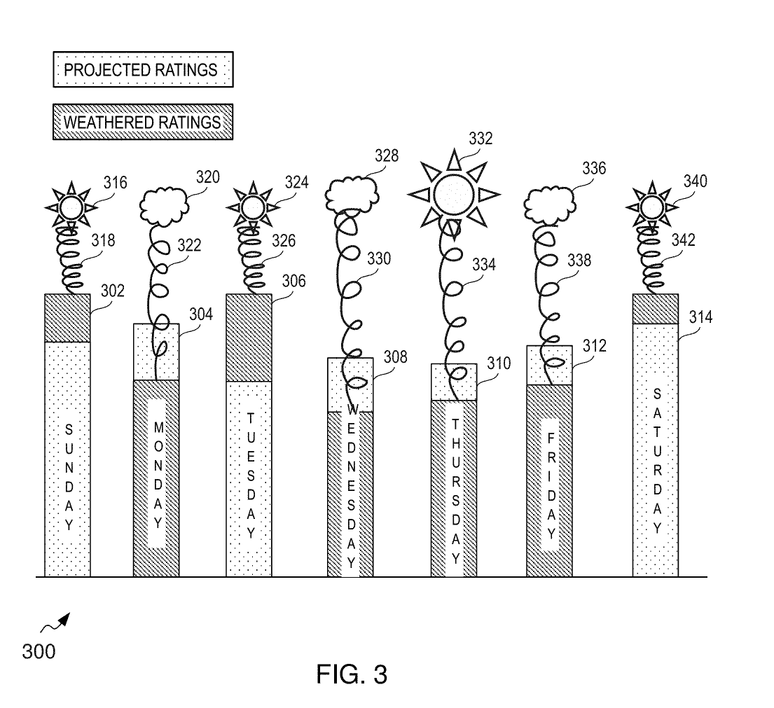

Referring now to FIG. 3, a schematic illustration depicting effects of weather on crowd projections is shown in accordance with an example embodiment. In general, weather factor influences crowd (number of people) at a location/business service. For instance, a hot sunny day with high temperatures (e.g., 37 degree Celsius) results in a very less crowd at a park but a clear sky with medium temperature (e.g., 23 degree Celsius) draws huge crowds. In an embodiment, weather information is used to project how rush trends at that location will deviate from historical trends. Historical trends are computed from historical data that aggregate crowd information from multiple sources over time. For instance, current weather at a location can alter the rush trend at the location that was derived based on historical data. For example, if it's raining or if the weather is too sunny then despite the historical trends suggesting a surge in crowd, the projected crowd information shows an adjusted trend that will be lower than a value corresponding to the historical trend. The effect of weather information on the rush trend at a location/business service is computed using Hooke's Law which allows simulation of a spring that stretches or contracts when weather conditions change and thus pulling or pushing ratings in either positive or negative direction. This is called ‘weathered crowd ratings’. The analysis of the effect of weathered information on the rush trend enables to determine accurate projections of crowd information in terms of rush status and wait time. It should be noted that temperature is taken merely as an example that affects the crowd, and there may be various other weather factors such as precipitation, snowfall, wind speed that can also heavily influence outdoor crowds. The weather information for a business service/location is obtained from weather services based on specific geo-coordinates of the business service/location of interest. In one embodiment, Hooke's law as given below may be used for the determining effect of weather information on the trend in a place/locality.

### Hooke's Law:

Hooke's law for a spring states that F is the restoring (reaction) force exerted by the spring on whatever is pulling its free end. The equation for Hooke's Law is shown below as equation (1)

F=−k*X (1)

In the above equation, k is a positive real number and X is a characteristic (e.g., stretch) of the spring. Moreover, the same formula holds when the spring is compressed, with F and X both negative in that case.

FIG. 3 shows a representative bar diagram 300 displaying crowd projections at a business service based on weather factor incorporated into historical data. In this representative diagram, each bar represents a day of the week, such as, Sunday 302, Monday 304, Tuesday 306, Wednesday 308, Thursday 310, Friday 312 and Saturday 314. Each bar is coupled to a weather factor by means of a spring. As shown in FIG. 3, Sunday 30:2 is coupled to weather factor 316 by means of spring 318, Monday 304 is coupled to a weather factor 320 by means of spring 322, Tuesday 306 is coupled to weather factor 324 by means of spring 326, Wednesday 308 is coupled to weather factor 328 by means of spring 330, Thursday 310 is coupled to a weather factor 332 by means of spring 334, Friday 312 is coupled to a weather factor 336 by means of spring 338 and Saturday 314 is coupled to a weather factor 340 by means of spring 342. The weather factors 316, 324 and 340 indicate almost ideal temperatures (e.g., warm and bright day with temperatures around 23 degree), the weather factors 320, 328, and 336 indicate low temperatures (e.g., cloudy and rainy day showing temperatures around 8 degree) and the weather factor 332 indicates a high temperature (e.g., hot day with temperature around 40 degree).

The weather factor is incorporated to alter trends that are usually based on historical data, such that ideal weather (ideal temperature, ideal precipitation, ideal wind, etc.) has an effect on crowd size at a given location/locality. Hooke's law is applied to exploit this behavior by placing (e.g., calculating) a spring between projected rush ratings and ideal weather conditions. In an embodiment, stiffness of springs 318, 322, 326, 330, 334, 338, 342 is governed by the weather factors 316, 320, 324, 328, 332, 336, 340, respectively. The spring will contract and pull up rush ratings (projected ratings) if weather conditions are getting close to ideal. For example, the weather factors 316, 324 and 340 indicate almost ideal temperatures and are coupled to bars 302, 306 and 314 (Sunday, Tuesday and Saturday) by means of springs 318, 326, 342 that are compressed, thereby increasing rush ratings. The weather ratings do not significantly affect the projected rating (ratings provided based on history/trend).

In an embodiment, extreme weathers, such as, extreme high temperature and extreme cold temperature exert a force on the spring and cause expansion of the spring, thereby lowering rush ratings. As shown in FIG. 3, extreme weathers depicted by weather factors 320, 328, 332, 336 cause springs 322, 330, 334, 338 coupled to bars 304, 308, 310, 312 (corresponding to Monday, Wednesday, Thursday, Friday, respectively) to expand, thereby lowering rush ratings. The rush ratings are lowered as the weather ratings greatly influence the projected ratings (ratings provided based on history/trend). The following table (Table. 2) illustrates effect of temperature factored into rush ratings.

TABLE 2

| Rounded | Weathered | Weather | Projected | Weathered | Normalize | Force | Actual | Constant | Ideal |
|---|---|---|---|---|---|---|---|---|---|
| Ratings | Ratings | Factor | Rating | Force | By | Factor | Temperature | K | Temperature |
| 3.89 | 3.885 | 0.885 | 3 | 88.5 | 100 | −11.5 | 0 | 0.5 | 23 |
| 3.94 | 3.935 | 0.935 | 3 | 93.5 | 100 | −6.5 | 10 | 0.5 | 23 |
| 3.99 | 3.985 | 0.985 | 3 | 98.5 | 100 | −1.5 | 20 | 0.5 | 23 |
| 4 | 4 | 1 | 3 | 100 | 100 | 0 | 23 | 0.5 | 23 |
| 3.97 | 3.965 | 0.965 | 3 | 96.5 | 100 | 3.5 | 30 | 0.5 | 23 |
| 3.92 | 3.915 | 0.915 | 3 | 91.5 | 100 | 8.5 | 40 | 0.5 | 23 |
| 3.87 | 3.865 | 0.865 | 3 | 86.5 | 100 | 13.5 | 50 | 0.5 | 23 |
| 3.82 | 3.815 | 0.815 | 3 | 81.5 | 100 | 18.5 | 60 | 0.5 | 23 |
| 3.77 | 3.765 | 0.765 | 3 | 76.5 | 100 | 23.5 | 70 | 0.5 | 23 |
| 3.72 | 3.715 | 0.715 | 3 | 71.5 | 100 | 28.5 | 80 | 0.5 | 23 |

As seen from Table. 2, the projected rating has been determined based on the historical data. The historical data is an aggregation of at least one of the rush status or the wait time at the business service over a time period. The force factor is determined based on Hooke's law where ‘X’ in the Hooke's law is determined as difference between the actual temperature and the ideal temperature. The weathered force is determined by normalizing the force factor obtained using Hooke's law. The weathered rating is sum of the projected rating and the weathered factor due to the weather condition at the business service on that day.

For example, if the projected rating at 2 PM in a coffee shop 4 rush rating (on a scale of 5) and wait time 15 minutes indicating a rush status of very crowded, weathered rating (due to snow) at 2 PM in the coffee shop is displayed as a 3-rush rating with wait time 10 min indicating moderately crowded based on the weather pattern in the crowd reporting interface to any user viewing the crowd information at the coffee shop via the crowd reporting interface. The crowd information displayed on the crowd reporting interface is a prediction of the crowd information considering the weather condition at the coffee shop.

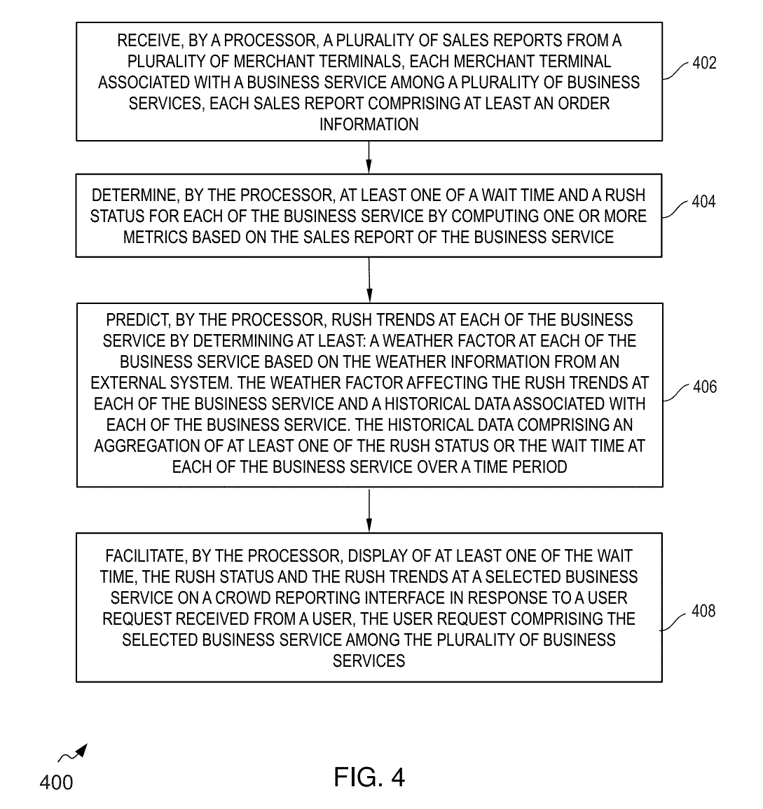

Referring now to FIG. 4, a flow diagram of an example method 400 for determining rush rating and wait time at a business service is illustrated in accordance with an example embodiment. The method 400 can be performed by the system 200 shown and explained with reference to FIG. 2.

The sequence of operations of the method 400 need not be necessarily executed in the same order as they are presented. Further, one or more operations may be grouped together and performed in form of a single step, or one operation may have several sub-steps that may be performed in parallel or in sequential manner.

At operation 402, the method 400 includes receiving, by a processor, a plurality of sales reports from a plurality of merchant terminals. Each merchant terminal associated with a business service among a plurality of business services. In an embodiment, each sales report comprises at least an order information. For instance, each business service is equipped with a merchant terminal that is configured to acquire orders. In various embodiments, the merchant terminal can be a telephone, a POS system or a computer system operated by an agent for performing payment transactions on behalf of a customer. Whenever, the customer buys goods or avails a service, transaction details pertaining to the goods/services is received by the processor. In an example, order data corresponding to one or more customers served at the business service for the past one hour is retrieved by the processor.

At operation 404, the method 400 includes determining, by the processor, at least one of a wait time and a rush status for each of the business service by computing one or more metrics based on the sales report of the business service. In an example, order data corresponding to one or more customers served at the business service for the past one hour is retrieved by the processor to determine operational efficiency of the business service. For instance, the operational efficiency of the business service can be computed in terms of rush status and wait time based on metrics such as, speed and response time using mechanical efficiency principle. For instance, assuming the business service had received 10 orders in the last one hour and 8 orders have been served, the operational efficiency in terms of speed is 80%. In another embodiment, the plurality of sales reports are used to determine sales based efficiency of the business service. Sales based efficiency is computed for business services where ticket-sale happens prior to start of an event and indicate number of orders completed on a specific day or time for a specific service. In an example, assuming a movie theatre has a capacity for 500 people whereas 100 tickets have been sold a day, the sales based efficiency of the business service is 20%. Determining operational efficiency and/or sales based efficiency of the business service has been explained in detail with reference to FIG. 2.

At operation 406, the method 400 includes predicting, by the processor, rush trends at each of the business service by determining at least: a weather factor at each of the business service based on the weather information and a historical data associated with each of the business service. The weather factor affects the rush trends at each of the business service and is determined from weather information associated with the business service. In an embodiment, the weather information may be received from external systems/databases, such as, the third party reporting service 128. The historical data comprises an aggregation of at least one of the rush status or the wait time at each of the business service over a time period. The rush trends at a business service are predicted using the historical data as baseline. The historical data is influenced by weather patterns at the business service. For instance, the historical data may predict rush trends that the business service may be crowded at a particular time of day. However, extreme weather pattern, say, high temperatures or heavy rain may influence the rush trends such that the number of people visiting the business service decreases and therefore decreases number of orders received by the business service. Predicting rush trends based on weather factor and historical data has been explained in detail with reference to FIG. 3.

At operation 408, the method 400 includes facilitating, by the processor, display of at least one of the wait time, the rush status and the rush trends at a selected business service on a crowd reporting interface. The wait time, the rush status and the rush trends at the selected business service is displayed in response to a user request received from a user. The user request comprises the selected business service among the plurality of business services. For instance, the user can access the crowd reporting interface on an associated user device. The user can search for the business service he/she intends to visit or receive crowd information. Alternatively, the user can access a business service list provided by the crowd reporting interface to select the business service for which he/she wants the crowd information.

In an embodiment, the processor also receives user reports from multiple users providing crowd information, such as, wait time and rush status for each of the business services in the vicinity. Additionally or optionally, the processor may also access crowd report from external systems such as to determine the wait time and the rush status at the business service. In an embodiment, the processor aggregates crowd information at a business service by aggregating the rush status and the wait time determined based on the sales report, the user report and the crowd report. When the processor receives the user request, the aggregated crowd information is displayed to the user in terms of the wait time, rush status and rush trends on the crowd reporting interface of the user device. The wait time, rush status and rush trends may be displayed as ratings, text information or as visual graphs that can be easily interpreted by the user.

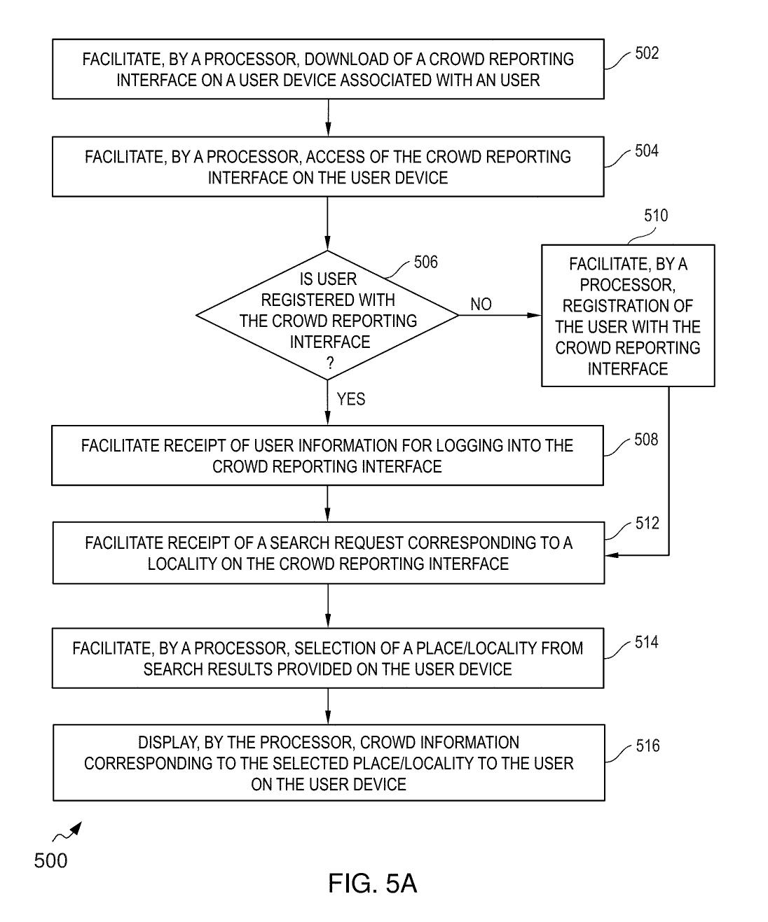

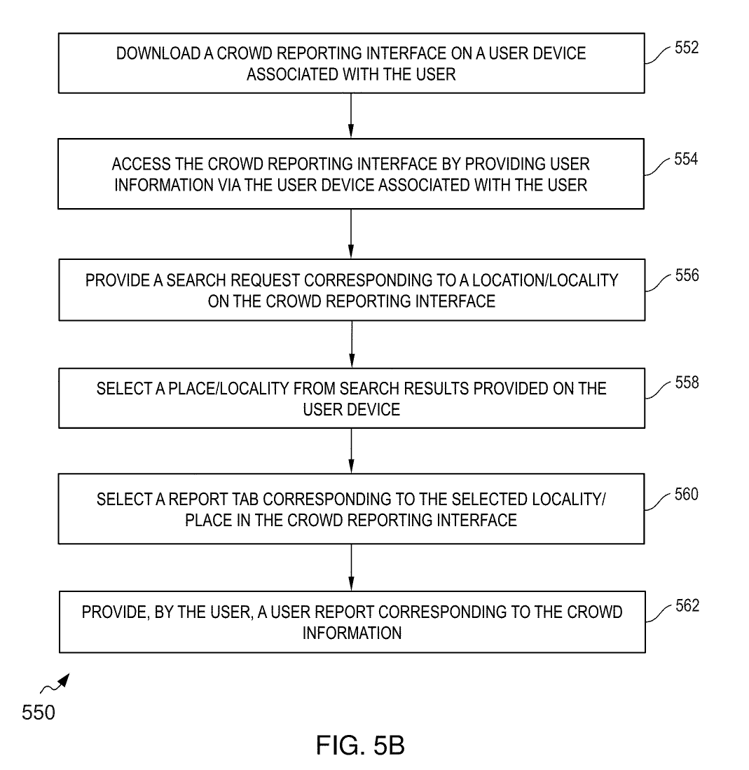

Referring now to FIG. 5A, a flow diagram of an example method 500 for receiving crowd information at a location or business service on a user device is illustrated in accordance with an example embodiment. The method 500 can be performed by the system 200 shown and explained with reference to FIG. 2.

At operation 502, the method 500 includes facilitating, by a processor, download of a crowd reporting interface on a user device associated with a user. The crowd reporting interface allows the user to receive real-time updates of crowd information at a location/business service. In an example, the crowd information is generated in terms of wait time (in minutes) for a service and rush status (on a scale of 5). Additionally, the user can also provide crowd information at a location/business service of close proximity that may be used to generate the crowd information. It shall be noted that the user report will be discarded if the proximity factor exceeds a proximity threshold. In an example, an instance of the crowd reporting interface is available on a server, such as, the server 130 (shown in FIG. 1). The user can request the instance of the crowd reporting interface via the user device (e.g., the device 114) associated with the user 112.

At operation 504, the method 500 includes facilitating, by the processor, access of the crowd reporting interface on the user device. The crowd reporting interface can be accessed in a guest mode (also referred to as offline mode) or an online mode. The guest mode enables user to receive crowd information from the interface without the user sharing his current location information. Alternatively, the user can choose to provide current location information using location services in the online mode. The online mode continuously tracks location of the user using the location services. However, it shall be noted that the location information of the user is required when the user reports crowd information via the crowd reporting interface at a location/business service for determining proximity factor.

At operation 506, the method 500 includes checking, by the processor, if the user is registered with the crowd reporting interface. If the user is registered with the crowd reporting interface, operation at 508 is performed; else operation at 510 is performed.

At operation 508, the method 500 includes facilitating receipt of user credentials for logging into the crowd reporting interface. The user credentials provided by the user while signing up for the crowd reporting interface are verified with credentials provided by the user while signing up with the crowd reporting interface for authenticating identity of the user. For instance, the user provides credentials such as, a user name, an Electronic Mail (email) identifier and a password for accessing the crowd reporting interface.

At operation 510, the method 500 includes facilitating, by the processor, registration of the user with the crowd reporting interface. In an embodiment, the user can register with the crowd reporting interface by providing the user credentials. The user credentials may include, but is not limited to, credentials such as, user name, Electronic Mail (Email) identifier, contact number, password and the like. Alternatively, the user can choose to register with the crowd reporting interface via social networking platforms, such as Facebook®. Registration of the user via social networking platforms enable the crowd reporting interface to access social profiles of the user.

At operation 512, the method 500 includes facilitating receipt of a search request corresponding to at least one of a location and business service on the crowd reporting interface. The user can search for a location/business service by providing a search string corresponding to the location/business service in a search tab provided on the crowd reporting interface. For instance, the user provides the search string, “XY Coffee Shop” in the search tab of the crowd reporting interface.

At operation 514, the method 500 includes facilitating, by the processor, selection of at least one location or business service from search results provided on the user device. The crowd reporting interface provides a list of location/business services that match with the search string (e.g., “XY Coffee Shop”) provided by the user. The user can select the location/business service of interest in the crowd reporting interface via the user device.

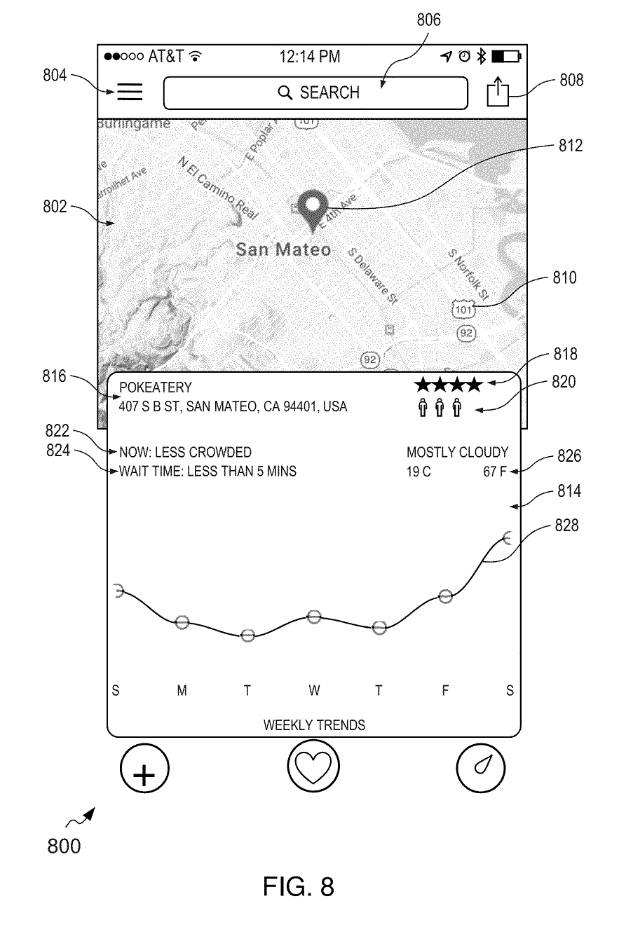

At operation 516, the method 500 includes displaying, by the processor, crowd information corresponding to the at least one location/business service selected by the user on the user device. The crowd information in terms of rush status (on a scale of 5) and wait time (in minutes) are displayed to the user based on the selected location/business service. For example, rush status for the “XY Coffee Shop” is displayed as 4 and wait time is displayed as 15 minutes. A server, such as, the system 200 aggregates crowd information received as reports via a plurality of users, business services and a third party service to generate the rush status and wait time for the selected location/business services. Analyzing reports and generating crowd information has been described with reference to FIG. 2. An example of the crowd reporting interface displaying crowd information is shown and explained with reference to FIG. 8.

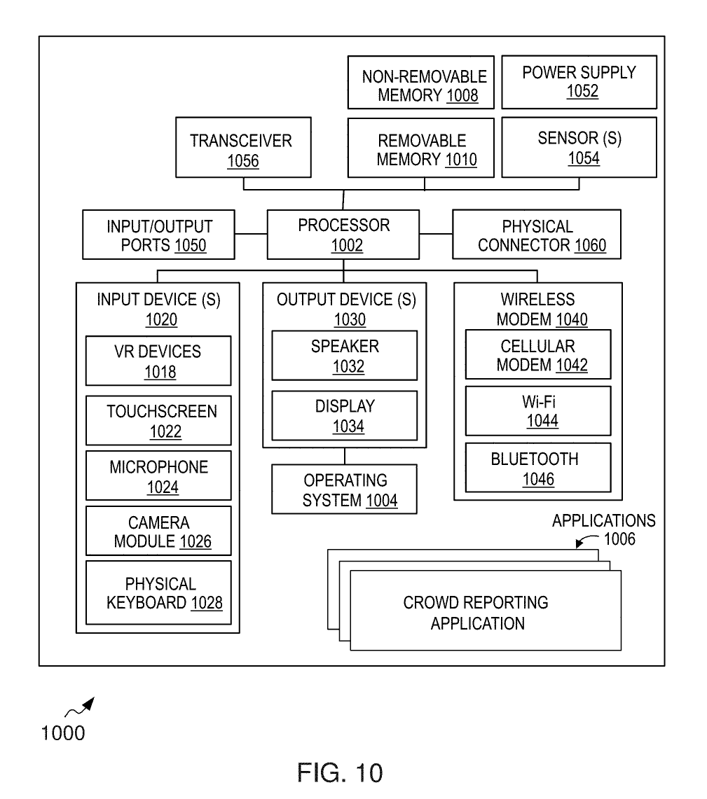

Referring now to FIG. 5B, a flow diagram of an example method 550 for for reporting crowd information at a location/business services by a user device is illustrated in accordance with an example embodiment. The method 550 can be performed by a mobile device 1000 shown and explained with reference to FIG. 10.

At operation 552, the method 550 includes downloading a crowd reporting interface on a user device associated with the user.

At operation 554, the method 550 includes accessing the crowd reporting interface by providing user information via the user device (e.g., the mobile device 1000) associated with the user. In an embodiment, the crowd reporting interface provides options for registration of a new user and log in options for users registered with the crowd reporting interface. The new user provides user credentials for registering with the crowd reporting interface. The users registered with the crowd reporting interface provide user credentials while logging in the crowd reporting interface for authenticating the user. User information may include, but is not limited to, user name, Electronic mail (Email) identifier, contact number, password and the like. Alternatively, the new user can choose to register via social networking platforms that are configured to share user information with the crowd reporting interface.

At operation 556, the method 550 includes providing a search request corresponding to at least one of a location and a business service on the crowd reporting interface. The user can search for a location/business service by providing a search string corresponding to the location/business services in a search tab provided on the crowd reporting interface. At operation 558, the method 550 includes selecting at least one of location or a business service from search results provided on the user device. The crowd reporting interface provides a list of location/business service that match with the search string provided by the user. The user can select the location/business service of interest in the crowd reporting interface via the user device.

At operation 560, the method 550 includes selecting a report tab corresponding to the at least one location or business service selected in the crowd reporting interface. The report tab allows the user to provide a user report based on crowd information corresponding to the selected location/business service. It must be noted that a processor, for example, embodying the report analyzer 210, ensures that the user report adheres to a frequency rule, a proximity rule, an interval rule and a freshness rule. The frequency rule ensures that the user can only provide ‘X’ user reports corresponding to ‘Y’ number of places per day where ‘X’ is determined by history of accuracy of the user reports and ‘Y’ is based on settings provided by the crowd reporting interface. The proximity rule ensures that the user can provide a user report corresponding to a location/business service only if the user is physically present at the place or in close proximity of the location/business service as determined by a proximity factor that is computed based on current location of the user. Alternatively, if location is not provided by the user or if incorrect location of the user is provided in the user report, the user report is discarded. The interval rule ensures that the user can provide a user report only after a fixed time interval that is determined by the crowd reporting interface. Further, the freshness rule indicates that stale reports that correspond to user reports that are older than ‘X’ (hours, minutes) are discarded.

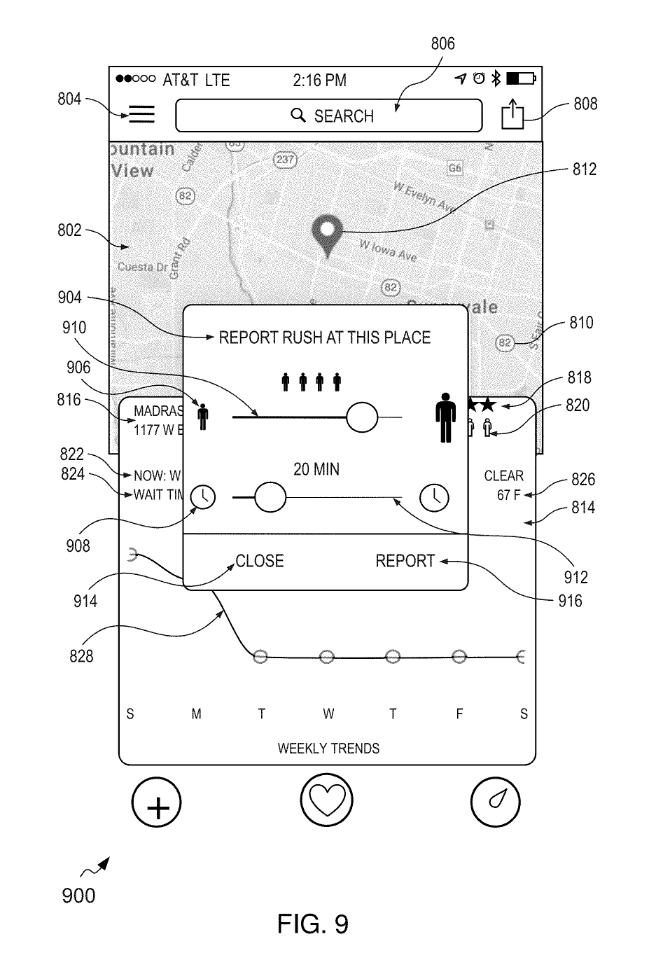

At operation 562, the method 550 includes providing, by the user, a user report corresponding to the crowd information. The user report comprises crowd information in terms of rush status (refer to Table. 1) on a scale of 5 and wait time to access a service (in minutes). In an embodiment, the user can adjust a toggle (shown in FIG. 9) to indicate rush status and wait time. Alternatively, the crowd reporting interface may prompt the user to select a value from a drop-down box or manually enter the values. An example of user providing the user report is shown and explained with reference to FIG. 9.

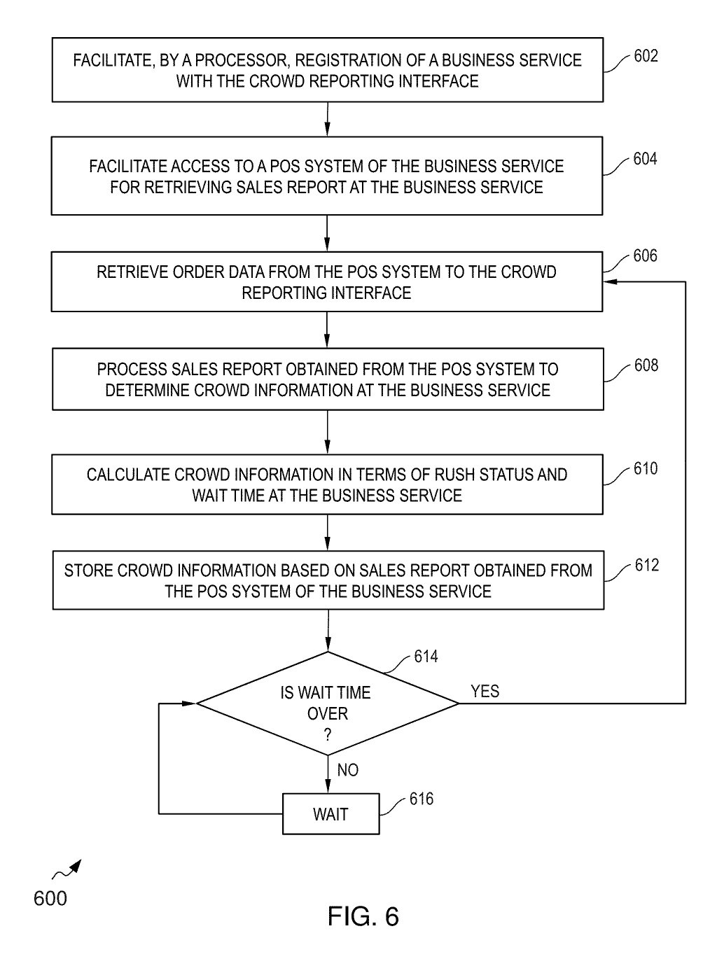

Referring now to FIG. 6, a flow diagram of an example method 600 of a business service providing a plurality of sales report for determining crowd information at the business service is illustrated in accordance with an example embodiment.

At operation 602, the method 600 includes facilitating, by a processor, registration of a business service with the crowd reporting interface. The business service via a contract will agree to provide sales report, such as, order and purchase information of the business service to a server (e.g., the server 130) on a timely basis to determine crowd information at the business service. This requires the business service to register with the crowd reporting interface by providing business service information and adhering to terms and conditions provided by the crowd reporting interface.

At operation 604, the method 600 includes facilitating access to a merchant terminal of the business service for retrieving sales report at the business service. At operation 606, the method 600 includes retrieving sales report comprising order data from the merchant terminal to the crowd reporting interface. A centralized server, for example, a server system 1100 that is configured to host and manage the crowd reporting interface. The server retrieves the sales report directly from the merchant terminal (POS systems) of the business service using APIs at specific intervals. For example, the centralized server may use the APIs to access the POS system of a coffee shop every hour to retrieve order data corresponding to number of orders received and number of orders served.

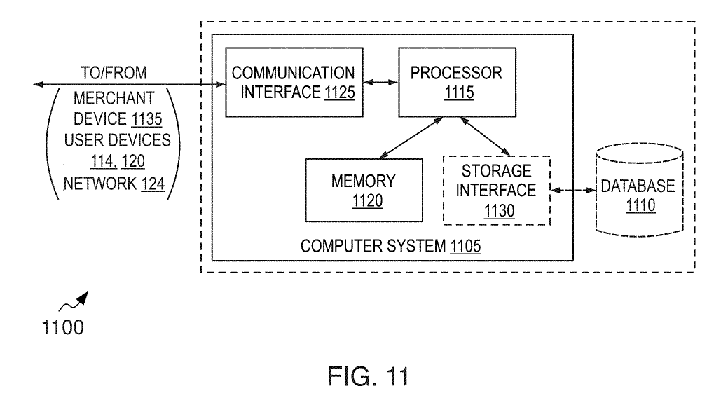

At operation 608, the method 600 includes processing the sales report obtained from the merchant terminal to determine crowd information at the business service. At operation 610, the method 600 includes calculating crowd information in terms of rush status and wait time at the business service. In an embodiment, a server, such as, the server system 1100 (shown in FIG. 11) analyses the order data obtained from the POS system to determine rush status (on a scale of 5) and wait time (in minutes). The crowd information can be calculated either based on operational efficiency of the business service or sales efficiency of the business service. Calculating crowd information based on operational efficiency and sales efficiency of the business service has been described with reference to FIG. 2.

At operation 612, the method 600 includes storing crowd information based on sales report obtained from the merchant terminal of the business service. At operation 614, the method 600 includes checking if an interval ‘T’ is over. If the interval is over, operation at 706 is performed else it waits for the interval ‘T’ (see, operation at 616) and thereafter operation 606 is performed. Accordingly, sales report is fetched from the POS system of the business service at fixed intervals that is determined based on terms and agreements between the business service and the crowd reporting interface.

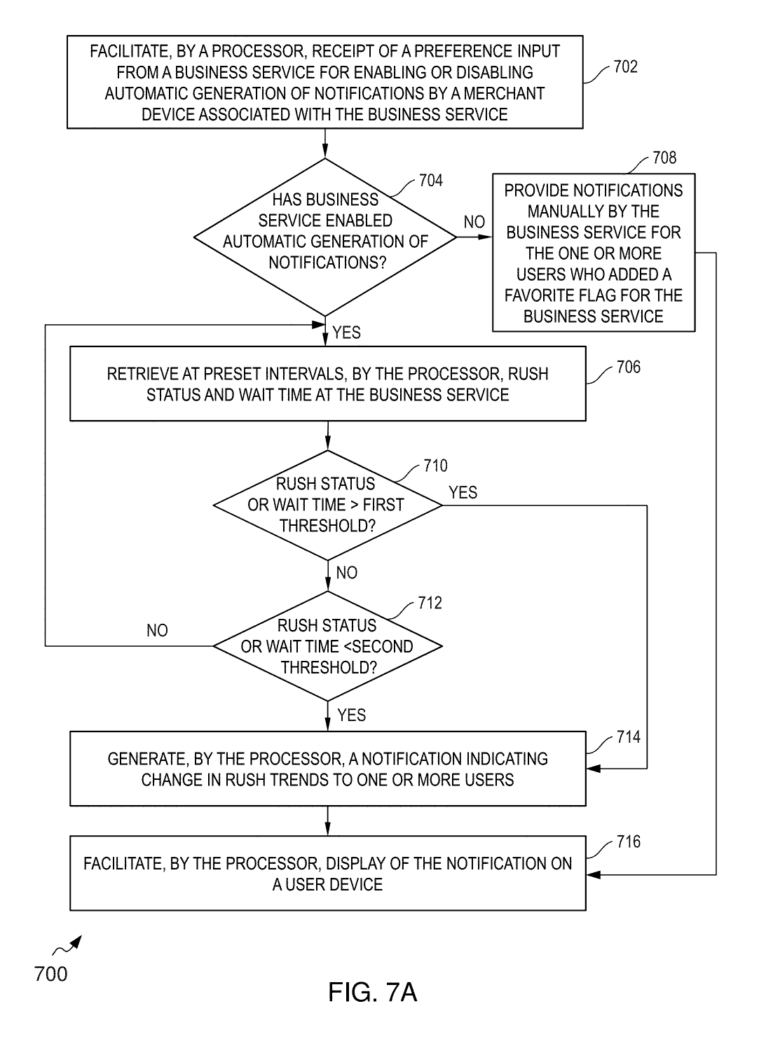

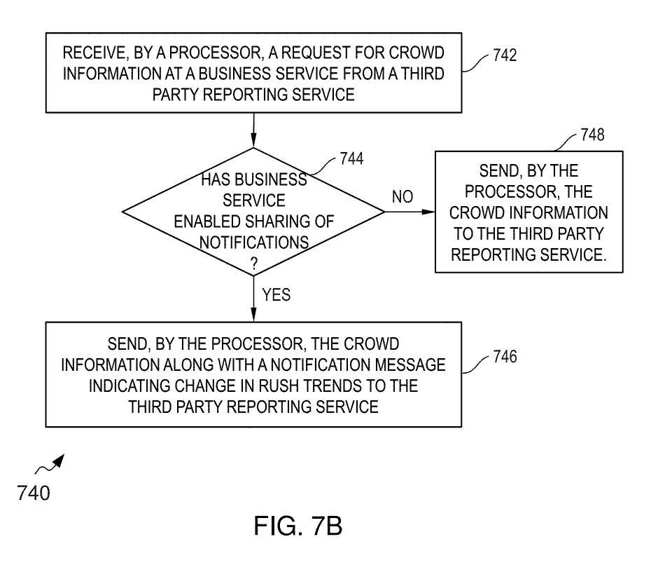

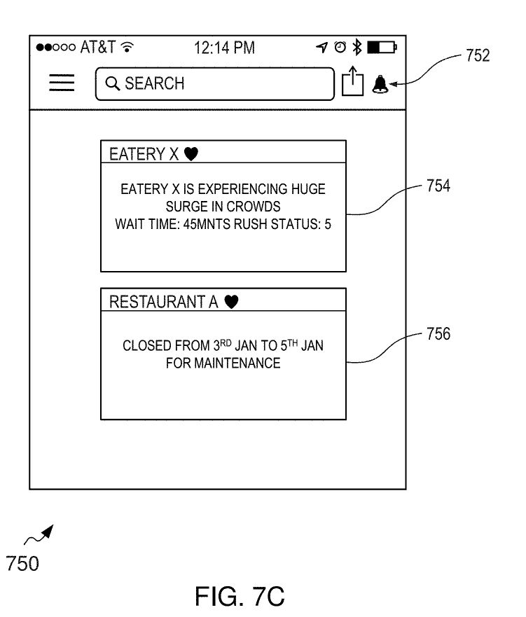

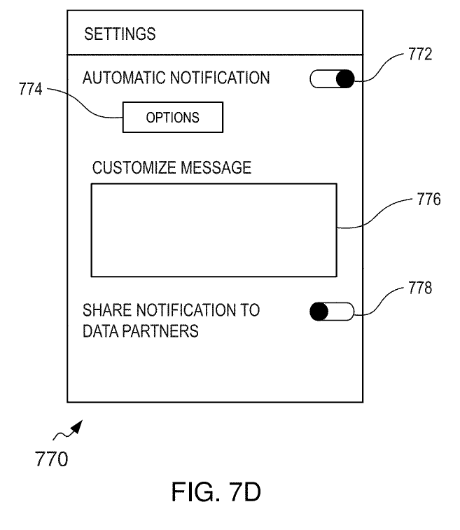

Referring now to FIG. 7A, a flow diagram of an example method 700 for sending a notification from a merchant terminal to one or more users is illustrated in accordance with an example embodiment.

At operation 702, the method 700 includes facilitating, by a processor, receipt of a preference input from a business service for enabling or disabling automatic generation of notifications by a merchant device associated with the business service. The business service can access a service provider interface of a crowd reporting interface for providing preferences on sending notification to customers (also referred to as ‘users’). The business service can share notifications with users who have added a favorite flag to the business service. The notifications comprise a message indicating change in rush trends at the business service. The notification can be generated automatically when a change in rush trend is observed by the merchant device or may be manually generated by the business service for the users. This requires a merchant associated the business service to provide preferences for generating notifications on the merchant device. An example of a setting page in the crowd reporting interface is shown and explained with reference to FIG. 7D.

At operation 704, the method 700 includes determining, by the processor, if the business service has enabled automatic generation of notifications. If the business service has enabled automatic generation of notifications, operation 706 is performed else operation 708 is performed.

At operation 706, the method 700 includes retrieving at preset intervals, by the processor, rush status and wait time at the business service. The rush status and the wait time at the business service are determined by the processor (e.g., the system 200) based on first party report, user report and third party report. The rush status and the wait time are compared against rush trends to analyze a change in the rush status and the wait time at preset intervals.

At operation 708, the method 700 includes providing notifications manually by the business service for the one or more users who added a favorite flag for the business service in a crowd reporting interface. If the business service chooses not to send notifications automatically based on change in rush trends, a merchant or a business administrator associated with the business service can login to the service provider interface of the crowd reporting interface to customize and send notifications to the users as desired. For example, a theatre may send notifications to the users when the theatre is closed for renovation such as to provide information to the users who had added a favorite flag. An example of the service provider interface for providing preferences and customizing messages is shown and explained with reference to FIG. 7D.

At operation 710, the method 700 includes determining, by the processor, if at least one of the rush status or the wait time is greater than a corresponding first threshold. If at least one of the rush status or the wait time is greater than the corresponding first threshold, operation 714 is performed else operation 712 is performed. The wait time/rush status greater than the first threshold indicate a surge in crowds at the business service that may be a deviation from the rush trend predicted by the processor on a crowd reporting interface.

At operation 712, the method 700 includes determining, by the processor, if at least one of the rush status or the wait time is less than a corresponding second threshold. If at least one of the rush status or the wait time is less than the corresponding second threshold, operation 714 is performed else operation 706 is performed. The wait time/rush status lesser than the corresponding second threshold indicate a drop in crowds at the business service that may be a deviation from the rush trend predicted by the processor on the crowd reporting interface. It shall be noted that the first thresholds and the second thresholds can be pre-set by the business administrator associated with the business service.

At operation 714, the method 700 includes generating, by the processor, a notification indicating change in the rush status or the wait time to one or more users who added a favorite flag for the business service in a crowd reporting interface. In both cases where the rush status and the wait time are greater than the corresponding first threshold or lesser than the corresponding second threshold, an abnormal deviation from rush trend as predicted based on historical data has to be communicated to the users who have added a favorite flag to the business service. The processor therefore sends out notifications to the users who have added the favorite flag to the business service. It shall be noted that the merchant associated with the business service may have provided a notification message via the merchant device that has to be sent out to the users when a change in rush trend has been identified by the processor. However, it shall be noted that the business service has a limit on number of notifications shared with the users in a day and a time interval between the notifications generated by the processor. For instance, a business service can provide a maximum of two notifications for a day with a minimum time interval of 3 hours. Moreover, the notification will adhere to ‘do not disturb’ option enabled by either the user on an associated user device or on the crowd reporting interface.

At operation 716, the method 700 includes facilitating, by the processor, display of the notification on a user device. The notification may include a message communicating the deviation in rush trend at the business service. Optionally, the notification may include wait time and rush status at the business service as shown and explained with reference to FIG. 7C.

Referring now to FIG. 7B, a flow diagram of an example method 740 for sending a notification to a third party reporting service is illustrated in accordance with an example embodiment. The operations of the method 740 may be performed by the server 1100 shown and explained with reference to FIG. 11.

At operation 742, the method 740 includes receiving, by a processor, a request for crowd information at a business service from a third party reporting service. In some example embodiments, the third party reporting service may request for crowd information such as to analyze and display statistics about crowd behavior. An example of the third party reporting service may be any governmental or private agencies working on licensed or outsourced projects. The third party reporting service can place an Application Programming Interface (API) request to the business service for crowd information comprising rush status and wait time at the business service. It shall be noted that the crowd reporting interface provides services for third party services, such as, the third party reporting services to access and/or acquire crowd information from one or more business services for research and analysis. However, the business services may choose to either share or prevent access to the crowd information of the business service by the third party reporting services based on preferences provided by the business services. In some embodiments, the crowd reporting interface provides a service provider interface for business services that may be accessed by the business service for providing preferences on access to crowd information and/or notifications of the business services.

At operation 744, the method 740 includes determining, by the processor, if the business service has enabled sharing of notifications with the third party reporting service. If the business service has enabled sharing of the notifications with the third party reporting service, operation 746 is performed else operation 748 is performed.

At operation 746, the method 740 includes sending, by the processor, the crowd information along with a notification message indicating change in rush trends to the third party reporting service. If the third party reporting service requests for crowd information at the business service, the processor may share the crowd information along with notifications generated by the business service if any based on the preference settings of the business service.

At operation 748, the method 740 includes sending, by the processor, the crowd information to the third party reporting service. If the business service chooses not to share notifications with the third party reporting services, the business service provides access only to the crowd information at the business service.

Referring now to FIG. 7C, a schematic representation of a crowd reporting interface 750 displaying notifications 754, 756 is illustrated in accordance with an example embodiment. When a user invokes the crowd reporting interface 750, the user may be provided with a UI displaying a home page of the crowd reporting interface 750. The home page displays a notification tab 752 at a top right corner of the crowd reporting interface 750. In an embodiment, the user can view notification messages by clicking on the notification tab 752.

In this example representation, the interface 750 displays the notification 754 followed by the notification 756. In an example, the user may have set a favorite flag for the business services (Eatery X, Restaurant A) based on the user interests. It shall be noted that the notifications 754, 756 are generated by different merchant terminals and relied to the user via the crowd reporting interface 750. The notification 754 corresponds to an eatery (Eatery X) and the notification 756 corresponds to a restaurant (Restaurant A) for which the user had set a favorite flag. In an example, the notification 754 is an automatic notification generated by a merchant terminal at the Eatery X. The merchant terminal of the eatery (Eatery X) may have generated the notification 754 in response to determining a change in rush trend compared to the rush trend predicted by a server (e.g., the server 1100) based on historical data of the Eatery X.

As seen in FIG. 7C, the notification 756 is a manual notification that has been customized and generated by a merchant terminal associated with the Restaurant A. For example, business administrators associated with the Restaurant A may have disabled automatic generation of notifications by the merchant terminal. In such cases, when the business administrators of the Restaurant X intend to communicate information related to the Restaurant X to users who have set a favorite flag for the Restaurant X, the business administrators may customize and generate a notification message that may be sent to the users. For example, if the Restaurant A is closed for maintenance on specific dates, the business administrators may manually generate the notification 756 indicating to the users that the Restaurant A is closed for maintenance. It shall be noted that the manual notification 756 appears on the crowd reporting.

Referring now to FIG. 7D, a service provider interface displaying a UI 770 of the crowd reporting interface is illustrated in accordance with an example embodiment. The UI 770 is displayed to a business administrator/merchant on a display screen of the merchant interface device 106 by the crowd reporting interface for receiving preference input for sending notifications. The service provider interface of the crowd reporting interface after invoking, may present one or more UIs for creating an account of the business service. The service provider interface may provide the UI 770 associated with a label ‘Settings’ for the business administrator of a business service to select preferences for sending notifications to users who have set a favorite flag for the business service. The UI 770 may be displayed to the business administrator upon selection of the option associated with the label ‘Settings’. It is noted that the provisioning of the Settings options is explained herein for illustration purposes and may not be considered to be limiting the scope of the disclosure. Indeed, the UI 200 may be displayed to the user, by selection of other options or options with different labels than the labels explained herein.

In this example representation, a left part of the UI 770 of the service provider interface displays an option for automatic sending of notifications to users and a right part displays a toggle button 772. The business administrator can move the toggle button 772 to enable (switch ON) or disable (switch OFF) automatic generation and sending of notifications from the merchant interface device (e.g., the merchant interface device 106). When the business administrator enables the toggle button 772 for sending notifications automatically to one or more users, the business administrator is provided with an options tab 774 providing options for setting a first threshold and a second threshold that provide an upper bound and a lower bound on allowed deviations from predicted rush trends at the business service and a message field 776 for customizing a notification message for the one or more users who have set the favorite flag for the business service.

The left part of the UI 770 of the service provider interface displays an option for sharing notifications with data partners and the right part displays the toggle button 778. The business administrator can move the toggle button 776 to enable (switch ON) or disable (switch OFF) sharing of notifications with data partners, such as the third party reporting service 128. When the business administrator enables the toggle button 776 for sending notifications automatically to data partners, the data partners can access crowd information and also receive notifications (both automatic and manual notifications) from the business service. The data partner can make available the notification message on a web portal providing information status of plurality of business services.

Referring now to FIG. 8, a schematic representation of a crowd reporting interface 800 is illustrated, in accordance with an example embodiment. The interface 800 is provided on devices, such as the mobile device 1000 shown and explained with reference to FIG. 10. The interface 800 displays a page 802 of the interface 800 when the user accesses the interface 800. The page 802 includes a menu tab 804, a search tab 806 and an upload tab 808 on the top part of the page 802. The menu tab 804 displays options provided by the crowd reporting interface 800. A user can use the search tab 806 to search for a locality/place of interest by providing a search string corresponding to the locality/place of interest. For instance, the user provides the search string corresponding to a restaurant/location for which the user would like to receive crowd information. The upload tab 808 allows the user to upload user report (or any images, document or file) based on crowd information to a centralized server, such as, the server 130.

The page 802 includes a location map 810 corresponding to the place/location selected by the user. The location map 810 displays surrounding areas and the place/location of interest is displayed by a pointer icon 812. As shown in FIG. 8, the pointer icon 812 is placed on the place/location as requested by the user. However, the user can choose to retrieve crowd information corresponding to a different place/location by moving the pointer icon 812 along the location map 810. The pointer icon 812 can be placed on a place/location of interest.

The page 802 includes a display card 814 that is configured to provide crowd information to the user requesting crowd information of a place/location. The display card 814 appears below the location map 810 on the interface 800 in response to a search request provided by the user in the search tab 806. Alternatively, when the user moves the pointer icon 812 on the location map 810 to a different place/location, the display card 814 rotates to provide crowd information based on movement of the pointer icon 812 on the location map 810. Additionally, the display card 814 can rotate to provide crowd information corresponding to sponsored places or recommended places.

As shown in FIG. 8, the display card 814 displays crowd information corresponding to the pointer icon 812 (“Pokeatery’ located as San Mateo). The display card 814 includes a location information 816 corresponding to the pointer icon 812 as shown below:

### Pokeatery

B St. San Mateo, Calif. 94401, USA

The display card 814 includes reviews 818 of the place/location, such as, 4 star rating that is provided for the location (Pokeatery) shown by the pointer icon 812. The reviews 818 of the place/location are aggregated from one or more sources, such as, a third party service and a first party service. The display card 814 displays average lifetime crowd ratings 820 of the crowd information indicating a moderate crowd at the place/location. As shown in FIG. 8, the current rush status (based on real-time crowd information) is displayed by a rush status text 822 and a current wait time 824. The rush status text 822 displays a text that reads “Less Crowded” (based on real-time crowd information). The current wait time 824 displays “less than 5 minutes” (based on real-time crowd information). The page 802 includes a weather information 826 that displays temperature (both in Celsius and Fahrenheit as 19 and 67, respectively) and a weather description as “Mostly cloudy” (shown in FIG. 8). The page 802 includes a trend graph 828 that displays trends of crowd information in the location (Pokeatery) on a weekly basis.

Referring now to FIG. 9, a schematic representation of user reporting crowd information on a crowd reporting interface 900 is illustrated in accordance with an example embodiment. The crowd reporting interface 900 displays a dialogue box 904 when the user selects a locality/location to report crowd information. The dialogue box 904 appears when the user selects report option from the menu tab 804 (shown in FIG. 8). Selecting a location/place on the location map 810 using the search tab 806 or the pointer icon 812 has been described with reference to FIG. 8. The dialogue box 904 is configured to receive crowd information from the user. The top portion of the dialogue box 904 displays a message, “Report rush at this place”. The dialogue box 904 includes a rush status icon 906 and a wait time icon 908. A first toggle 910 is placed adjacent to the rush status icon 906 and a second toggle 912 is placed adjacent to the wait time icon 908. The toggles 910 and 912 are adjustable and can be adjusted by moving the toggles 910, 912 to reflect the crowd information. As shown in FIG. 9, the user adjusts the toggle 910 to represent rush status of 4 indicating ‘moderate crowd’ corresponding to the location/locality selected by the user on the location map 810. The user moves the toggle 912 to reflect wait time as 20 minutes (shown in FIG. 9) for accessing service at the location/locality selected by the user.

The dialogue box 904 includes a close tab 914 and a report tab 916 at bottom part of the dialogue box 904. The user can click on the close tab 914 if he chooses not to report the crowd information corresponding to the location/locality selected by the user on the location map 810. The user clicks on the report tab 916 to submit crowd information provided by the user using the toggles 910, 912 corresponding to the location/locality selected by the user on the location map 810.

FIG. 10 is a schematic block diagram of a mobile device 1000 that is capable of implementing embodiments for accessing a crowd reporting interface in the mobile device 1000. It should be understood that the mobile device 1000 as illustrated and hereinafter described is merely illustrative of one type of device and should not be taken to limit the scope of the embodiments. As such, it should be appreciated that at least some of the components described below in connection with the mobile device 1000 may be optional and thus in an example embodiment may include more, less or different components than those described in connection with the example embodiment of the FIG. 10. As such, among other examples, the mobile device 1000 could be any of a mobile electronic device, for example, personal digital assistants (PDAs), mobile televisions, gaming devices, cellular phones, tablet computers, laptops, mobile computers, cameras, mobile digital assistants, or any combination of the aforementioned, and other types of communication or multimedia devices.

The illustrated mobile device 1000 includes a controller or a processor 1002 (e.g., a signal processor, microprocessor, ASIC, or other control and processing logic circuitry) for performing such tasks as signal coding, data processing, image processing, input/output processing, power control, and/or other functions. An operating system 1004 controls the allocation and usage of the components of the mobile device 1000 and support for one or more applications programs (see the crowd reporting interface 132), such as a crowd reporting interface for reporting crowd information in terms of rush status and wait time in a locality/place. Additionally, the crowd reporting interface includes provisions to retrieve crowd information in terms of rush status and wait time for a locality/place. In addition, to reporting and retrieving the crowd information, the application programs can include common mobile computing applications (e.g., telephony applications, E-mail applications, calendars, contact managers, web browsers, messaging applications) or any other computing application.

The illustrated mobile device 1000 includes one or more memory components, for example, a non-removable memory 1008 and/or a removable memory 1010. The non-removable memory 1008 can include RAM, ROM, flash memory, a hard disk, or other well-known memory storage technologies. The removable memory 1010 can include flash memory, smart cards, or a Subscriber Identity Module (SIM). The one or more memory components can be used for storing data and/or code for running the operating system 1004 and the applications 1006. Example of data can include web pages, text, images, sound files, image data, video data, or other data sets to be sent to and/or received from one or more network servers or other devices via one or more wired or wireless networks. The mobile device 1000 may further include a user identity module (UIM) 1012. The UIM 1012 may be a memory device having a processor built in. The UIM 1012 may include, for example, a subscriber identity module (SIM), a universal integrated circuit card (UICC), a universal subscriber identity module (USIM), a removable user identity module (R-UIM), or any other smart card. The UIM 1012 typically stores information elements related to a mobile subscriber. The UIM 1012 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The mobile device 1000 can support one or more input devices 1020 and one or more output devices 1030. Examples of the input devices 1020 may include, but are not limited to, a touchscreen 1022 (e.g., capable of capturing finger tap inputs, finger gesture inputs, multi-finger tap inputs, multi-finger gesture inputs, or keystroke inputs from a virtual keyboard or keypad), a microphone 1024 (e.g., capable of capturing voice input), a camera module 1026 (e.g., capable of capturing still picture images and/or video images) and a physical keyboard 1028. Examples of the output devices 1030 may include, but are not limited to a speaker 1032 and a display 1034. Other possible output devices (not shown in the FIG. 10) can include piezoelectric or other haptic output devices. Some devices can serve more than one input/output function. For example, the touchscreen 1022 and the display 1034 can be combined into a single input/output device.

A wireless modem 1040 can be coupled to one or more antennas (not shown in the FIG. 10) and can support two-way communications between the processor 1002 and external devices, as is well understood in the art. The wireless modem 1040 is shown generically and can include, for example, a cellular modem 1042 for communicating at long range with the mobile communication network, a Wi-Fi compatible modem 1044 for communicating at short range with an external Bluetooth-equipped device or a local wireless data network or router, and/or a Bluetooth-compatible modem 1046. The wireless modem 1040 is typically configured for communication with one or more cellular networks, such as a GSM network for data and voice communications within a single cellular network, between cellular networks, or between the communication system and a public switched telephone network (PSTN).

The mobile device 1000 can further include one or more input/output ports 1050, a power supply 1052, one or more sensors 1054 for example, an accelerometer, a gyroscope, a compass, or an infrared proximity sensor for detecting the orientation or motion of the mobile device 1000, a transceiver 1056 (for wirelessly transmitting analog or digital signals) and/or a physical connector 1060, which can be a USB port, IEEE 1394 (FireWire) port, and/or RS-232 port. The illustrated components are not required or all-inclusive, as any of the components shown can be deleted and other components can be added.

With the application (see 1006) and/or other software or hardware components, the mobile device 1000 can implement the technologies described herein. For example, the processor 1002 can facilitate registration of a user in the crowd reporting interface, facilitate receipt of crowd information corresponding to a place/locality from a user, process requests of the user for retrieving crowd information corresponding to a locality/place and facilitate display of the crowd information in terms of rush status and wait time.

Although the mobile device 1000 is illustrated in FIG. 10 in form of a smartphone, but more particularly, the techniques and solutions described herein can be implemented with connected devices having other screen capabilities and device form factors, such as a tablet computer, a smart device, and the like. Without in any way limiting the scope, interpretation, or application of the claims appearing below, a technical effect of one or more of the example embodiments disclosed herein is to provide a method and system for multi-sourced crowd reporting of crowd information in a locality/location using the mobile device 1000 via the application 1006 that retrieves crowd information corresponding to a locality/place and receives crowd information from the user corresponding to a locality/place.

FIG. 11 is a block diagram of a server 1100 configured to host and manage the crowd reporting interface 132 that is provided to mobile devices such as the mobile devices 114, 120 (or the mobile device 1000) in accordance with an example embodiment of the invention. An example of the server 1100 is the system 200 shown and described with reference to FIG. 2. The server 1100 includes a computer system 1105 and a database 1110.

The computer system 1105 includes at least one processor 1115 for executing instructions. Instructions may be stored in, for example, but not limited to, a memory 1120. The processor 1115 may include one or more processing units (e.g., in a multi-core configuration).

The processor 1115 is operatively coupled to a communication interface 1125 such that the computer system 1105 is capable of communicating with a remote device such as a merchant device 1135 (e.g., the merchant terminal 106) or communicates with any entity within the network 124. For example, the communication interface 1125 may receive a plurality of sales reports from the merchant device 1135 and determine crowd information, such as, wait time and rush status at corresponding business service (e.g., the merchant facility 102). The communication interface 1125 may receive user reports comprising crowd information from a plurality of users via user device (e.g., the user devices 114, 120).

The processor 1115 may also be operatively coupled to the database 1110. The database 1110 is any computer-operated hardware suitable for storing and/or retrieving data, such as, but not limited to, sales reports, order data, user reports, third party report and crowd information in terms of rush status, wait time generated from the sales reports. The database 1110 stores crowd information of business services/locations such as to maintain historical data that may be accessed by the processor 1115 to compute rush trends at the business service/location at any given time. The database 1110 may also include instructions for displaying at least one of the wait time, the rush status and the rush trends at a business service/location selected by the user via the devices 114, 120 on a crowd reporting interface in response to a user request received from a user. The database 1110 may include multiple storage units such as hard disks and/or solid-state disks in a redundant array of inexpensive disks (RAID) configuration. The database 1110 may include a storage area network (SAN) and/or a network attached storage (NAS) system.

In some embodiments, the database 1110 is integrated within the computer system 1105. For example, the computer system 1105 may include one or more hard disk drives as the database 1110. In other embodiments, the database 1110 is external to the computer system 1105 and may be accessed by the computer system 1105 using a storage interface 1130. The storage interface 1130 is any component capable of providing the processor 1115 with access to the database 1110. The storage interface 1130 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1115 with access to the database 1110.

The processor 1115 is configured to facilitate display of at least one of the wait time, the rush status and the rush trends at a selected business service on a crowd reporting interface in response to a user request received from a user via a user device. The processor 1115 is further configured to receive a plurality of sales reports from merchant terminals associated with a business service. The processor 1115 is further configured to perform: receive user reports, sales reports and third party reports, compute one or more metrics based on the sales reports retrieved from the business service, determine at least one of a wait time and a rush status for the business service based on the user report, sales report and the third party report, predict rush trends at the business service based on weather factor. The processor 1115 is also configured to display visual statistics corresponding to the crowd information at the user devices (e.g., the user devices 114, 120) requesting crowd information at the business service via the communication interface 1125.

Various example embodiments disclosed herein are capable of displaying crowd information of a location/locality to a user via a crowd reporting interface on a user device. Additionally, the user can provide crowd information of a location/locality to the crowd reporting interface. Various example embodiments suggest techniques to receive reports based on crowd information from multiple sources and analyse the reports to accurately display crowd information conforming to a location/locality in terms of rush status and wait time. Further, multi-sourced information gathering provides accurate results and eliminates reliance on single source. Furthermore, the crowd reporting interface computes trends based on weather factors that affect crowd information. Moreover, the crowd reporting interface collects and processes order data of a first party reporting service to determine crowd information directly from the business service.

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 10 and/or 11. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the invention.

What is claimed is:

1. A method, comprising:
receiving, by a processor, a plurality of sales reports from a plurality of merchant terminals, each merchant terminal associated with a business service among a plurality of business services, each sales report comprising at least an order information;
determining, by the processor, at least one of a wait time and a rush status for each of the business service by computing one or more metrics based on the sales report of the business service;
predicting, by the processor, rush trends at each of the business service by determining at least:
a weather factor at each of the business service based on a weather information, the weather information affecting the rush trends at each of the business service received from an external system; and
a historical data associated with each of the business service, the historical data comprising an aggregation of at least one of the rush status or the wait time at each of the business service over a time period; and
facilitating, by the processor, a display of at least one of the wait time, the rush status and the rush trends at a selected business service on a crowd reporting interface in response to a user request received from a user, the user request comprising the selected business service among the plurality of business services.

2. The method as claimed in claim 1, further comprising:
facilitating, by the processor, registration of the plurality of business services with the crowd reporting interface for providing access to the plurality of sales reports from the plurality of merchant terminals associated with the plurality of business services.

3. The method as claimed in claim 1, further comprising:
facilitating, by the processor, receipt of a plurality of user reports comprising at least the wait time and the rush status, each user report associated with at least one of a business service or a location among a plurality of locations, each user report provided by the user accessing the crowd reporting interface on an associated user device.

4. The method as claimed in claim 3, further comprising:
determining, by the processor, a proximity factor of the user providing the user report by determining a distance measure between the user and the business service; and discarding, by the processor, the user report of the user when the proximity factor exceeds a distance threshold.

5. The method as claimed in claim 3, further comprising:
determining, by the processor, a proximity factor of the user providing the user report by determining a distance measure between the user and the location; and
discarding, by the processor, the user report of the user when the proximity factor exceeds a distance threshold.

6. The method as claimed in claim 3, further comprising:
determining, by the processor, a reporting frequency of the user on the crowd reporting interface; and
discarding, by the processor, the user report of the user when the reporting frequency exceeds a pre-defined reporting threshold.

7. The method as claimed in claim 3, wherein facilitating display further comprises:
accessing, by the processor, a crowd information from the external system, wherein the crowd information is used for determining a crowd report comprising at least the wait time and the rush status for each of the business service or the location.

8. The method as claimed in claim 7, further comprising:
aggregating, by the processor, the wait time and the rush status for each business service based at least on the user report, the sales report of the business service and the crowd report.

9. The method as claimed in claim 7, further comprising:
aggregating, by the processor, the wait time and the rush rating for each location based at least on the user report and the crowd report.

10. The method as claimed in claim 1, wherein facilitating display comprises:
receiving, by the processor, the user request for accessing the crowd reporting interface from a user device associated with the user; and
facilitating, by the processor, selection of at least one business service on the crowd reporting interface from the plurality of business services.

11. The method as claimed in claim 1, wherein facilitating display comprises:
receiving, by the processor, the user request for accessing the crowd reporting interface from a user device associated with the user;
facilitating, by the processor, selection of at least one location on the crowd reporting interface from a plurality of locations; and
facilitating, by the processor, the display of at least one of the wait time, the rush status and the rush trends at the at least one location.

12. The method as claimed in claim 1, further comprising:
receiving, by the processor, a preference input from each of the plurality of merchant terminals for generation of notifications to one or more users by the merchant terminal associated with the business service, wherein the notifications are generated automatically when the preference input is enabled and the notifications are generated manually when the preference input is disabled.

13. The method as claimed in claim 12, further comprising:
determining, by the processor, if at least one of the wait time and the rush status of a business service is greater than a corresponding first threshold, the first threshold determined based on the historical data; and
sending, by the processor, a notification to one or more user devices associated with the one or more users based on a favorite flag set for the business service by the one or more users on the crowd reporting interface, wherein the notification comprising crowd information is automatically generated by the merchant terminal associated with the business service.

14. The method as claimed in claim 12, further comprising:
determining, by the processor, if at least one of the wait time and the rush status of a business service is less than a corresponding second threshold, the second threshold determined based on the historical data; and
sending, by the processor, a notification to one or more user devices associated with the one or more users based on a favorite flag set for the business service by the one or more users on the crowd reporting interface, wherein the notification comprising crowd information is automatically generated by the merchant terminal associated with the business service.

15. The method as claimed in claim 12, wherein a business administrator associated with the merchant device of the business service creates the notification for the one or more users based on a favorite flag set for the business service by the one or more users on the crowd reporting interface.

16. The method as claimed in claim 12, wherein the notification is at least one of a text, an image, an audio signal and a video signal.

17. The method as claimed in claim 1, wherein the one or more metrics of each business service is computed from the sales report of the business service using a mechanical efficiency.

18. A system, the system comprising:
a memory comprising stored instructions; and
at least one processor, configured to execute the stored instructions to cause the system to perform at least:
receive a plurality of sales reports from a plurality of merchant terminals, each merchant terminal associated with a business service among a plurality of business services, each sales report comprising at least an order information;
determine at least one of a wait time and a rush status for each of the business service by computing one or more metrics based on the sales report of the business service;
predict rush trends at each of the business service by determining at least:
a weather factor at each of the business service based on a weather information, the weather information affecting the rush trends at each of the business service received from an external system; and
a historical data associated with each of the business service, the historical data comprising an aggregation of at least one of the rush status or the wait time at each of the business service over a time period; and
facilitate display of at least one of the wait time, the rush status and the rush trends at a selected business service on a crowd reporting interface in response to a user request received from a user, the user request comprising the selected business service among the plurality of business services.

19. The system as claimed in claim 18, wherein the system is further caused to:
facilitate registration of the plurality of business services with the crowd reporting interface for providing access to the plurality of sales reports from the plurality of merchant terminals associated with the plurality of business services.

20. The system as claimed in claim 18, wherein the system is further caused to:
facilitate receipt of a plurality of user reports comprising at least the wait time and the rush status, each user report associated with at least one of the business service or a location among a plurality of locations, each user report provided by the user accessing the crowd reporting interface on an associated user device.

21. The system as claimed in claim 20, wherein for facilitating display the system is further caused to:
access a crowd information from the external system, wherein the crowd information is used for determining a crowd report comprising at least the wait time and the rush status for each of the business service or the location.

22. The system as claimed in claim 21, wherein the system is further caused to:
aggregate the wait time and the rush status for each of the business service based at least on the user report, the sales report of the business service and the crowd report.

23. The system as claimed in claim 21, wherein the system is further caused to:
aggregate the wait time and the rush status for each location based at least on the user report and the crowd report.

24. A method, the method comprising:
facilitating, by a processor, a receipt of a user request on a crowd reporting interface, the user request comprising a location;
determining, by the processor, at least a wait time and a rush status at the location based at least on:
a user report provided by a user on the crowd reporting interface, the user report being provided by the user in proximity with the location;
a sales report comprising at least an order information from a merchant terminal associated with the location; and
a crowd report of the location from an external system;
predicting, by the processor, rush trends at the location by determining at least:
a weather factor at the location based on a weather information, the weather information affecting the rush trends at the location received from the external system; and
a historical data associated with the location, the historical data comprising an aggregation of at least one of the rush status or the wait time at the location over a time period; and
facilitating, by the processor, a display of at least one of the wait time, the rush status and the rush trends at the location on the crowd reporting interface in response to the user request.

25. The method as claimed in claim 24, further comprising:
aggregating, by the processor, the wait time and the rush status for the location based at least on the user report, the sales report and the crowd report.
